(19) United States
(12) Patent Application Publication
(10) Pub. No.: US 2026/0178659 A1
(43) Pub. Date: Jun. 25, 2026

(54) GENERATIVE SEARCH SYSTEM

(71) Applicant: Netflix, Inc., Los Gatos, CA (US)

(72) Inventors: Kathryn Claire Campbell, Durham, NC (US); Yibo Dai, Palo Alto, CA (US); Jeremey Fleischer, Bend, OR (US); Benjamin Allan Johnson, San Jose, CA (US); Bryan Scott Hill, Milwaukie, OR (US)

(21) Appl. No.: 18/989,490

(22) Filed: Dec. 20, 2024

(51) Int. Cl. G06F 16/732; G06F 16/738; G06F 40/284

(52) U.S. Cl. CPC G06F 16/732; G06F 16/738; G06F 40/284

(57) ABSTRACT

A computer-implemented method includes receiving a query at a media streaming platform for media items that are to be provisioned by the media streaming platform. The method also includes analyzing the query to determine a level of breadth associated with the query, where the level of breadth indicates a degree of specificity associated with the query. The method further includes identifying media items that match the query then presenting the identified media items in an interactive user interface. The identified media items are visually presented in a manner that corresponds to the determined level of breadth associated with the query. Various other methods, systems, and computer-readable media are also disclosed.

### BACKGROUND

Media streaming platforms provide on demand movies and television programs to electronic devices all over the world. These media streaming platforms typically carry a wide variety of different television shows and movies that can be streamed to client devices at the client's request. At least in some cases, users of a media streaming platform may find movies or shows to watch based on a keyword search. In such cases, users will typically provide a word such as “Gladiator” or a more generic term such as “action movie,” and the media streaming platform will find movie or tv show titles that match the more specific or the more generic keywords provided by the user. While these search results may be satisfactory in some situations, in many cases, especially when search terms are more generic, the search results may lack the relevance desired by the user.

### SUMMARY

As will be described in greater detail below, the present disclosure generally describes systems and methods for presenting media items in an interactive user interface according to properties of an underlying search query.

In one example, for instance, a computer-implemented method includes receiving a query at a media streaming platform for media items that are to be provisioned by the media streaming platform. The method next includes analyzing the query to determine a level of breadth associated with the query, where the level of breadth indicates a degree of specificity associated with the query. The method also includes identifying media items that match the query, and then presenting the identified media items in an interactive user interface. The identified media items are visually presented in a manner that corresponds to the determined level of breadth associated with the query.

In some cases, the query is a natural language query. In some embodiments, the level of breadth calculated for the natural language query includes a breadth score that indicates a degree of specificity relative to other previously analyzed queries. In some examples, visually presenting the identified media items in a manner that corresponds to the determined level of breadth associated with the query includes presenting a single identified media item for a level of breadth that is below a specified threshold value. In some cases, visually presenting the identified media items in a manner that corresponds to the determined level of breadth associated with the query includes presenting multiple identified media items for a level of breadth that is above a specified threshold value.

In some embodiments, the method further includes presenting, in the interactive user interface, various portions of textual information indicating why the identified media items were presented in the interactive user interface. In some examples, the method further includes training a large language model (LLM) to generate the textual information indicating why the identified media items were presented in the interactive user interface. In some embodiments, training the LLM includes feeding the LLM multiple different inputs including multiple previous queries, multiple identified media items that were identified in response to the previous queries, and/or multiple modified portions of textual information indicating why the identified media items were presented in the interactive user interface.

In some cases, the trained LLM is implemented to identify the media items that match the query. In some examples, the trained LLM is further trained to avoid identifying specific media items as matches to some predetermined queries. In some embodiments, the portions of textual information indicating why the identified media items were presented in the interactive user interface are written in conversational language generated by the LLM. In some cases, the portions of textual information indicating why the identified media items were presented in the interactive user interface include tags. In some cases, the identified matches are lexical matches that are lexically matched to the query. In some instances, the lexical matches are performed by the LLM, and in other cases, the lexical matches are performed by a different module or system layer.

In some cases, the method further includes presenting, in the interactive user interface, one or more suggested prompts that are configured to be added to the received query to further refine the resulting identified media items. In some embodiments, the method further includes receiving inputs via the suggested prompts and adding those inputs to an existing search to further refine the resulting identified media items. In some examples, the method further includes adding a sub-search bar to the interactive user interface that allows a user to enter a secondary, clarifying search query. In some cases, the method further includes receiving a secondary, clarifying search query via the sub-search bar and then performing an updated search using the query and the secondary, clarifying search query. In some embodiments, the method also includes updating the interactive user interface to show different media items based on the query and the secondary, clarifying search query.

A corresponding system includes at least one physical processor and physical memory including computer-executable instructions that, when executed by the physical processor, cause the physical processor to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

In some examples, a corresponding non-transitory computer-readable medium is provided that includes one or more computer-executable instructions that, when executed by at least one processor of a computing device, cause the computing device to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for presenting media items in an interactive user interface according to properties of an underlying search query.

FIGS. 3A-3C illustrate embodiments of an interactive user interface in which media items are presented according to properties of an underlying search query.

FIGS. 4A-4B illustrates an alternative embodiment of an interactive user interface in which media items are presented according to properties of an underlying search query.

FIG. 5 illustrates an alternative embodiment of an interactive user interface in which media items are presented according to properties of an underlying search query.

FIG. 6 illustrates an alternative embodiment of an interactive user interface in which media items are presented according to properties of an underlying search query.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to providing media items in an interactive user interface according to properties of the underlying search query. As noted above, many different media streaming platforms are available to customers today. These media streaming platforms provide on-demand movies, television programs, and other media items to users' electronic devices. These media streaming platforms typically provide a keyword search feature that allows users to find movies or shows to watch based on words or phrases provided by a user.

For example, if a user knew in advance which movie or tv show they wanted to watch, the user could input a specific word such as “Friends.” The user interface for that media streaming platform would then present the tv show “Friends” or similar titles that the word “Friend” or related terms. Alternatively, the user may search for more generic terms such as “true crime.” The media streaming platform would then search for movie or tv show titles that match the true crime genre. In traditional platforms, these search results would be provided in the same manner, whether the search was for an exact title or whether the search was for a more generic search term. Moreover, at least in some cases, the media streaming platform may return search results that have little to do with the search terms provided by the user. That user may have no idea why certain titles are presented as supposedly matching the search terms they provided, especially when the titles shown seem unrelated to the user's search terms.

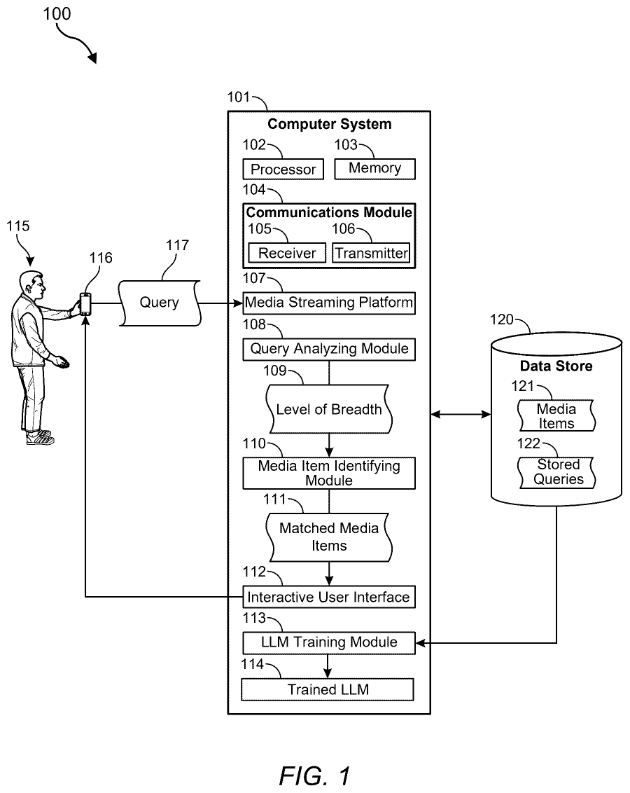

In contrast to these situations, the systems described herein analyze the search terms provided by the user. These systems determine, based on the analysis, whether a search term is broad or specific. Then, the systems present search results in a manner that is in line with the level of breadth intended in the search. Accordingly, if a user provided a very specific search term, the systems herein would provide user interface results that were highly focused and specific to the search term, potentially showing fewer results. And, on the other hand, if a user provided a broader search term or phrase, these systems would provide search results that were more inclusive in nature and showed more results related to the search. In this manner, the systems herein present media items in a manner that aligns with one or more of the properties of the underlying search query. This makes the search results more intuitive and understandable to the user and gives the user more or fewer choices based on the determined intended breadth of their search. These embodiments will be described in greater detail below with reference to FIGS. 1-9.

FIG. 1, for example, illustrates a computing environment 100 in which media items are presented in an interactive user interface according to properties of an underlying search query. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes a media streaming platform 107. The media streaming platform 107 interacts with data store 120 to access and provision media items 121 to users (e.g., to client device 116 of user 115). The media streaming platform 107 may include a variety of different servers and networking components. Thus, in some cases, the computer system 101 is a server within the media streaming platform 107 and, in other cases, the computer system 101 controls or otherwise interacts with other servers within the media streaming platform.

In some cases, the media streaming platform 107 receives queries from a user. For instance, the media streaming platform 107 may receive query 117 from user 115. The user 115 may input a keyword or key phrase via an interactive user interface 112 that is provisioned by and/or generated by the computer system 101. The keyword or key phrase is sent to the media streaming platform 107 as a query 117 for one or more media items 121 that are to be served to the client device 116 on demand.

Upon receiving the query 117, the query analyzing module 108 analyzes the query to determine the level of breadth associated with the query. The determined level of breadth 109 indicates how broad or narrow the search term or terms are. A narrow search term is a word or phrase that represents an exact title or a portion of a title (e.g., “Superman” or “dragon”). A broader search term may be a word or phrase such as an actor's name (e.g., “Tom Cruise”) that returns a large number of movies that star Tom Cruise. An even broader search term would be “action movie” or “romance” or “new release tv shows.” Each of these searches would return large numbers of search results. Accordingly, in this manner, the query analyzing module 108 analyzes incoming queries to determine their overall level of breadth 109 and then assigns each query a breadth level score.

The media item identifying module 110 identifies media items that match the received query and then provides the matched media items 111 to the interactive user interface 112. At least in some cases, the interactive user interface 112 includes a search bar, a results area in which title cards representing the media items are shown, and a description area which provides a brief description of the media items that were returned in the search. In some embodiments, the interactive user interface 112 provides a modified user interface that changes based on the level of breadth 109 associated with the user's search query. The modified user interface is provided to the client device 116 for presentation to the user 115. The user 115 can then see and interact with the modified user interface. At least in some cases, the user interface 112 will show more initial results for broader queries and will show fewer initial results for narrower queries. Moreover, the search results may be dynamically presented in a different manner based on the query's determined level of breadth 109. These concepts will be described in greater detail with respect to method 200 of FIG. 2 and FIGS. 1-9 below.

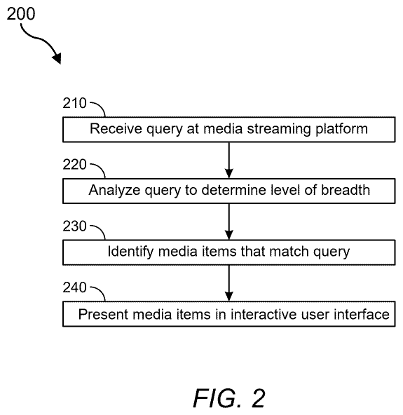

FIG. 2 is a flow diagram of an exemplary computer-implemented method 200 for presenting media items in an interactive user interface according to properties of an underlying search query. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for receiving a query at a media streaming platform for one or more media items that are to be provisioned by the media streaming platform. At step 220, the method 200 includes analyzing the query to determine a level of breadth associated with the query, where the level of breadth indicates a degree of specificity associated with the query. Then, at step 230, the method 200 includes identifying one or more media items that match the query and, at step 240, presenting the identified media items in an interactive user interface, where the identified media items are visually presented in a manner that corresponds to the determined level of breadth associated with the query.

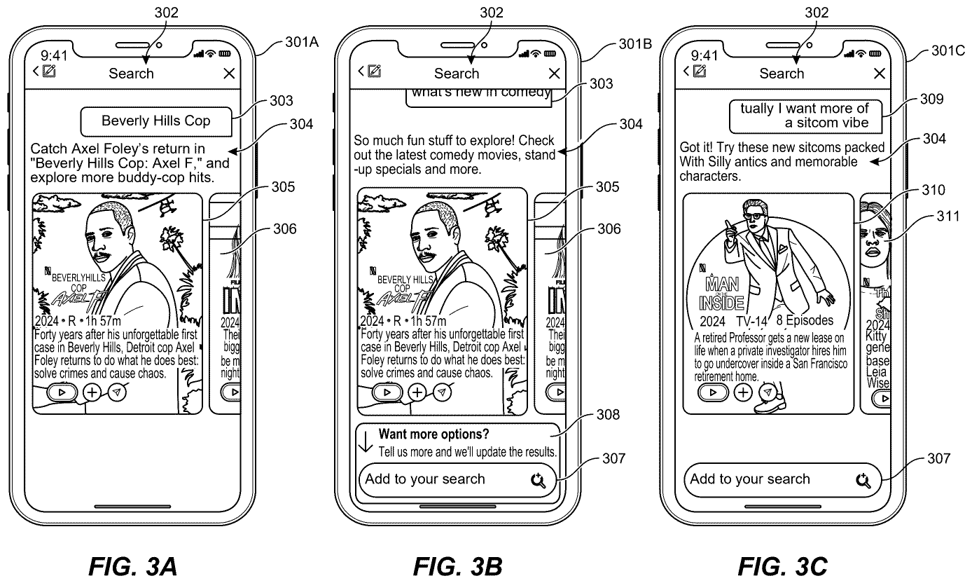

FIGS. 3A-3C, for example, illustrate an embodiment in which a media streaming platform receives a query, determines a level of breadth associated with the query (or determines other properties associated with the query), performs a search for media items and then presents those media items based on the determined level of breadth. As used herein, the terms “level of breadth” or simply “breadth” denote a search term's specificity in conveying an intended meaning. For example, if the user provides an exact title name, the system will determine that user's intent is to find an exact title. Such a search is highly specific and has a low level of breadth. Thus, in such cases, the user interface 301A will be generated to show a low number of specific results (e.g., one or two results).

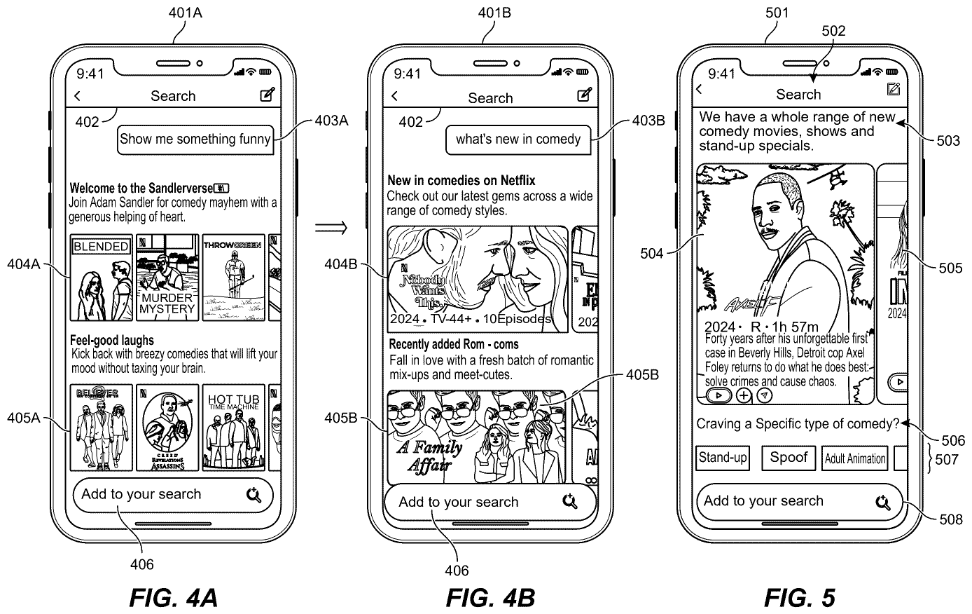

For instance, if a user inputs the term “Beverly Hills Cop” into a search bar 302, that search will be indicated within the search indicator box 303. The system may return a single title card 305 or may return the single title card 305 and a portion of a second title card 306. The title card 305 shows an image associated with the underlying media item, along with a description of the media item. Because the search term “Beverly Hills Cop” was highly specific, only a single title card was shown in the user interface 301, or a single title card with a small portion of a second title card. As will be described further below with regard to FIG. 4A, a broader search term or phrase with a higher level of breadth will result in multiple different title cards being shown. In some cases, the number of title cards shown in response to a search corresponds to or is commensurate with the level of breadth associated with the search terms.

In FIG. 3B, the user interface 301B is configured to present additional information for searches with larger breadth. For instance, if a user initially searches for “new comedies” or “what's new in comedy,” these search terms are somewhat broader, and the user interface 301B will then present additional options that appear when search terms of larger breadth are provided. In user interface 301B, for example, the search entered into search bar 303 is “what's new in comedy.” The underlying system will find recently released comedies and present them as title cards 305 and 306. The title cards will also be presented with additional information and search options, including information 304, and search options 307 and 308. At least in some cases, the identified matches are lexical matches that are lexically matched to the query. The lexical matches may be based on previous searches and users' reactions to those search results (e.g., whether or not the user selected any of the titles returned by the lexical search).

The system also generates narrative text 304 displayed above the title cards. The narrative text 304 is related to the provided search terms and consists of natural language that generates excitement for or increased interest in the provided search terms. The user interface is also modified to include an additional options bar 308 that acts as a header to an additional search bar 307. The additional search bar 307 allows users to enter searches that are applied on top of the additional search, or said another way, allows users to search within the already-retrieved search results. Users may use this additional search bar 307 to add additional search terms or phrases that have a different feel or a different vibe.

For example, as shown in FIG. 3C, the user has provided, as an additional input in the additional search bar 307, the phrase “Actually I want more of a sitcom vibe.” The interactive user interface 301C thus shows the search bar 302, as well as the new search term in box 309. The natural language text 304 describes, in plain terms, the new results that are designed to fit both search terms “what's new in comedy” and “Actually I want more of a sitcom vibe.” The new search result title cards 310 and 311 are now shown in the interactive user interface 301C. The interactive user interface 301C also shows an additional search bar 307 that allows the user to even further refine their search, such that the search could include third, fourth, fifth, or further search terms, where each search builds on and further defines the others. In this manner, the user can provide highly refined searches that lead to titles the user would be interested in streaming.

Turning now to FIG. 4A, a user may provide a broader search term, such as a genre (e.g., romantic comedies) or a phrase such as “show me something funny,” as noted in the search bar 403A of a search screen 402 within user interface 401A. The underlying system will analyze the search term or phrase input by the user and determine that the user's intent is to find a title that is funny. This search will draw on the user's past preferences and potentially on the preferences of other users that have searched using a similar term or phrase. The system will determine that the level of breadth of this search is high (i.e., “something funny” may return many hundreds or thousands of different movies or tv shows). In some cases, for example, the system may determine the breadth of the search by determining how many media titles result from the search. In other cases, the search term or phrase is analyzed semantically to determine whether the term is open-ended or is more specific. In such cases, where the level of breadth is determined to be large, the interactive user interface 401A is dynamically changed or generated to show the results in a manner that reflects the breadth of the search.

As can be seen in FIG. 4A, for example, the search “show me something funny” has resulted in six different titles being presented (e.g., 404A and 405A), with seventh and eighth titles being partially visible. Thus, instead of presenting one or two titles for narrower searches, the system will show an increased number of titles based on the increased breadth of the search. The underlying system is designed to allow search queries that are written in the user's natural language. As such, queries such as “show me something funny” can be processed and analyzed for intent. The level of breadth is then calculated for the natural language query. The level of breadth includes a breadth score that indicates a degree of specificity. At least in some cases, the degree of specificity is relative to other previously analyzed queries (e.g., that request “action movies” or “Adam Sandler comedies” or “romance movies starring Julia Roberts”). The user interface 401A, with the resulting media items, is then presented in a manner that corresponds to the determined level of breadth associated with the natural language query.

As noted above, the level of breadth may be a finite value that takes into consideration the determined level of breadth for other, previously received search terms or phrases. Presenting the resulting media items in a manner that corresponds to the determined level of breadth associated with the query may include presenting one single identified media item (and/or part of a second title card) for a level of breadth that is below a specified threshold value (e.g., a very low level of breadth, such as an exact title search). In other cases, presenting the resulting media items in a manner that corresponds to the determined level of breadth associated with the query includes presenting many different media items for a level of breadth that is above a specified threshold value (e.g., a search for “thrillers”). Accordingly, if the level of breadth is above a specified value, the user interface (e.g., 401A) will present many different media items and may also include additional textual description and/or additional search bars.

In some embodiments, as shown in FIG. 4B, the additional search bar 406 is a “sub-search bar” that is located below the main search bar 403B in the search screen 402 of the interactive user interface 401B. The additional search bar 406 allows the user to enter secondary or tertiary, clarifying search queries. If the user adds a clarifying query in sub-search bar 406 (e.g., adding “what's new in comedy” to “show me something funny”), the updated, refined search will search for comedies, but more specifically, comedies that have come out recently (e.g., new releases). As such, the title cards 404B and 405B will be updated to include fewer results (since the level of breadth has decreased), and the user will continue to be given the ability, via sub-search bar 406, to provide further clarifying search queries. Then, if the user provides a clarifying search query via the sub-search bar 406, the computer system 101 will perform an updated search using both the initial query and the secondary, clarifying search query. The computer system 101 will also dynamically update the interactive user interface 401B to show different (and fewer) media items based on both the initial query and the secondary, clarifying query.

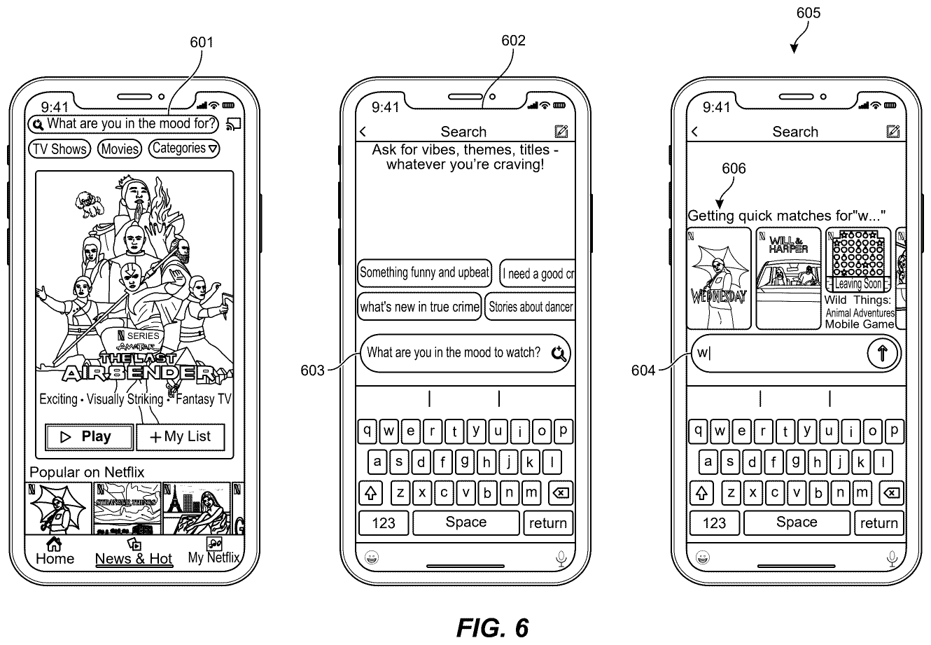

At least in some cases, as shown in FIG. 5, the interactive user interface will present one or more portions of textual information indicating why the identified media items were presented in the interactive user interface (e.g., text 503). This text 503 is written in natural language or, more specifically, conversational language that is designed to give a brief introduction to the resulting titles and to imbue excitement on the content available on the media streaming platform. The user interface 501 of FIG. 5 also provides suggested prompts or tags that allow the user to further drill down into a search.

For example, below the titles 504 and 505 that are returned in a given search (e.g., 502), the interactive user interface 501 provides tags that allow the user to further refine their search and find something more specific. For instance, if the user searched for “what's new in comedy,” the interactive user interface 501 would present text asking the user if they are craving a specific type of comedy 506. The UI would also provide various tags 507 that allow the user to further refine the search results based on the tags 507. In some cases, for instance, the tags 507 include “Stand-up” to narrow the comedy-based search to stand-up comedies, “Spoof” to narrow the comedy-based search to spoof comedies, “Adult Animation” to narrow the comedy-based search to adult animation comedies, as well as potentially other tags. If one of these tags is selected, the term in the tag is added to the user's search. In other cases, the user can further refine their search by adding search terms in the additional search bar 508. In some embodiments, these additional search terms are used in addition to or instead of the selected tags 507.

Thus, the computer system (e.g., 101) generates an interactive user interface 501 that presents, within the interactive user interface, one or more suggested prompts (e.g., tags 507) that are configured to be added to the initial query 502 to further refine the resulting media items. The computer system 101 also receives inputs from among the suggested prompts and adds those inputs to an existing search to further refine the resulting identified media items. The refined search may also result in dynamic changes to the interactive user interface, either adding additional title cards if the refined search is broader in breadth or removing title cards if the refined search is narrower in breadth.

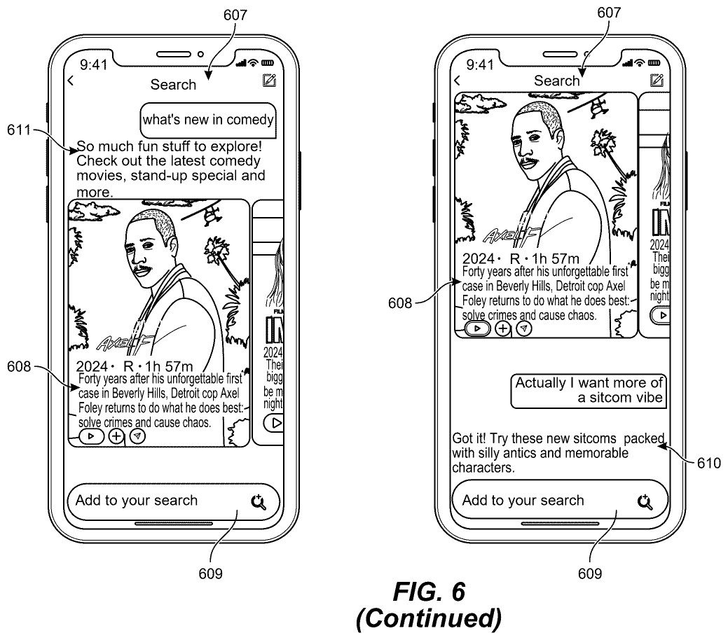

In some embodiments, computer system 101 of FIG. 1 includes a large language model (LLM) training module 113. The LLM training module 113 is configured to train LLMs to perform specific actions. In some cases, the trained LLMs may be or may function as artificial neural networks, designed to process and analyze large amounts of data. In some embodiments, the trained LLM 114 is trained to generate textual information indicating why specific media items were presented in an interactive user interface. For instance, as shown in FIG. 6, a user may respond to a prompt 601 asking “What are you in the mood for?” At least in some embodiments, selecting the prompt 601 acts as an entry into a specific search experience as described further below.

User interface 602 shows an updated screen with text at the top of the UI prompting the user to “Ask for vibes, themes, titles-whatever you're craving!” The UI 602 then presents various tags that can be entered as search inputs (e.g., “Something funny and upbeat,” “What's new in true crime,” etc.). The user can select these tags to begin a search, or the user can enter text via the search bar 603. If the user begins typing (e.g., entering a “w” in 604 of UI 605), the system will lexically match the “w” to media titles that begin with a “w.” Those titles are then presented on the screen as the user types. Explanatory text 606 indicates to the user what is currently happening (e.g., “Getting quick matches for “w . . . ”).

If the user inputs “what's new in comedy,” the system provides title cards in UI 607, along with text 611 explaining why the given title cards were chosen. As part of the training process, the LLM is fed a plurality of inputs including multiple previous queries (e.g., stored queries 122 in FIG. 1), along with media items that were identified in response to the previous queries, and modified portions of textual information indicating why the identified media items were presented in the interactive user interface. One example of such text 611 is shown in UI 607, where the text is related to comedy and generates further interest in the comedy-related search. The sub-search bar 609 allows the user to add additional terms or phrases to their initial search. In some cases, the trained LLM 114 is implemented to identify the media items that match the query. These media items are then presented in the interactive UI 607 (e.g., title card 608). The text at 610 above the sub-search bar 609 represents a generated response to the user input “Actually I want more of a sitcom vibe.”

In some embodiments, the LLM may generate further text for the UI, including natural language, conversational text that prompts the user to refine their search. This text may be part of a proposed search tag that is selectable within the interactive user interface. For instance, in FIG. 5, the user may select the “Stand-up” tag to search for a specific type of comedy. The system may then generate the following natural language response: “Got it! Here are some of our latest stand-up specials, from both comedy legends and up-and-coming talent.” The user may then enter a follow-up input such as “Actually I want more of a sitcom vibe” or similar. In this manner, the trained LLM 114 may be trained not only to generate text for the UI that inspires further search refinements, but also identifies which media items match both the initial search and the refined search.

In this process, the LLM may be further trained and modified to avoid identifying specific media items as matches to specific predetermined queries. For instance, if some queries contain socially unacceptable terms, the LLM may be trained to avoid matching videos to those terms and, instead may be trained to ask the user to change their search terms or provide alternative suggested search terms in the form of tags that are easily selectable. In this manner, the systems herein provide interactive user interfaces that change based on the characteristics of the search terms and further implement LLMs to generate the changes for those interactive user interfaces.

In addition to the above-described method, a system may be provided that includes at least one physical processor and physical memory comprising computer-executable instructions that, when executed by the physical processor, cause the physical processor to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

Still further, in addition to the above-described method, a non-transitory computer-readable medium may be provided that includes one or more computer-executable instructions that, when executed by at least one processor of a computing device, cause the computing device to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

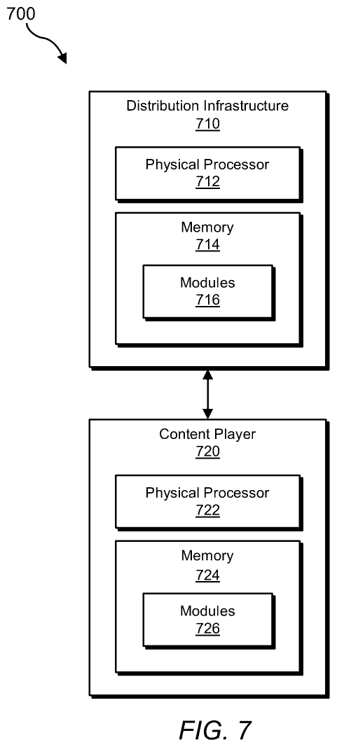

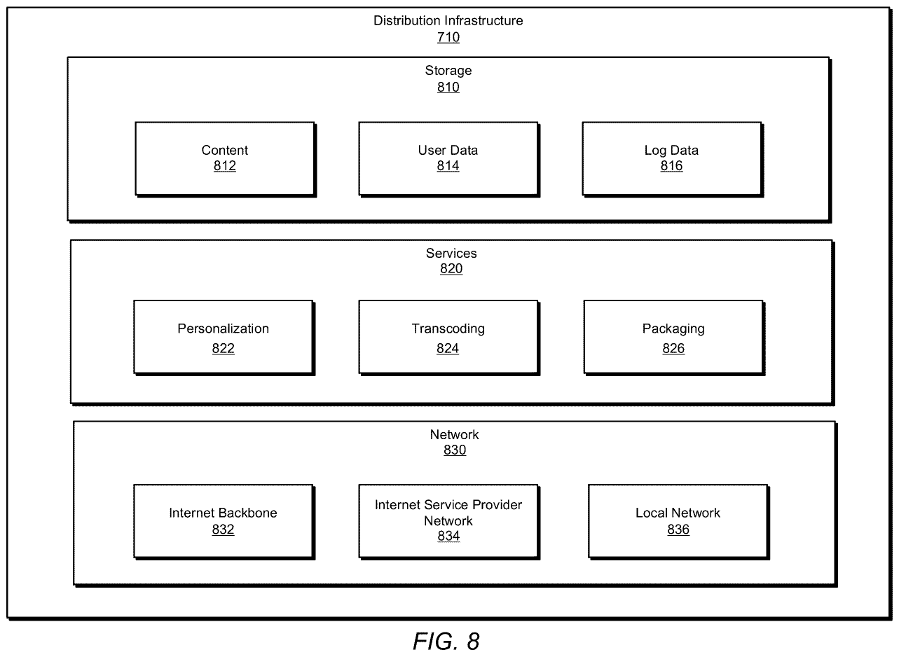

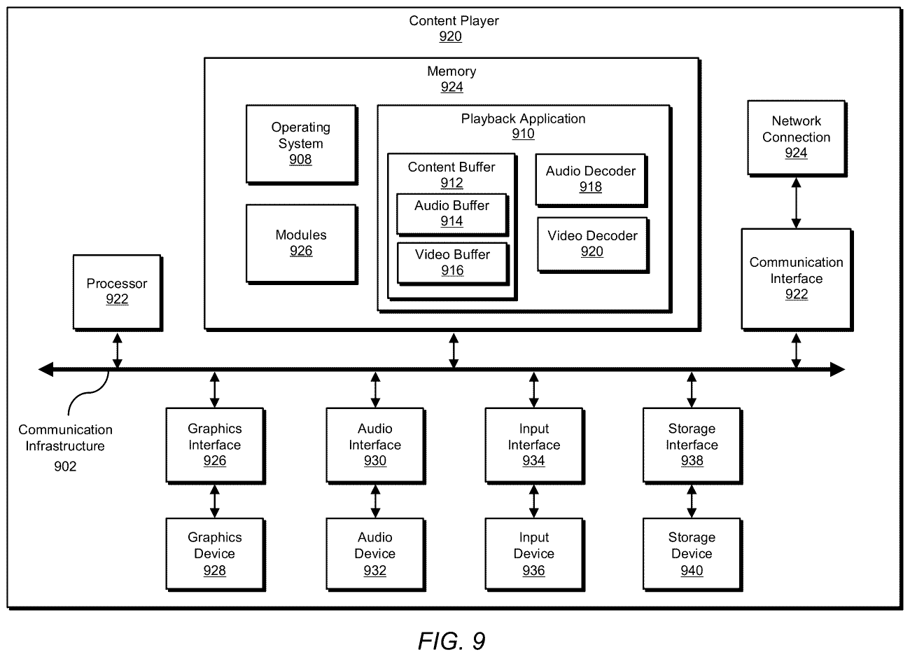

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-9.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and at least one memory 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Encoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926. Graphics interface 926 is configured to transmit a rendered video signal to graphics device 928. In normal operation, playback application 910 receives a request from a user to play a specific title or specific content. Playback application 910 then identifies one or more encoded video and audio streams associated with the requested title. After playback application 910 has located the encoded streams associated with the requested title, playback application 910 downloads sequence header indices associated with each encoded stream associated with the requested title from distribution infrastructure 710. A sequence header index associated with encoded content includes information related to the encoded sequence of data included in the encoded content.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### EXAMPLE EMBODIMENTS

Example 1: A computer-implemented method comprising: receiving a query at a media streaming platform for one or more media items that are to be provisioned by the media streaming platform, analyzing the query to determine a level of breadth associated with the query, the level of breadth indicating a degree of specificity associated with the query, identifying one or more media items that match the query, and presenting the identified media items in an interactive user interface, wherein the identified media items are visually presented in a manner that corresponds to the determined level of breadth associated with the query.

Example 2. The computer-implemented method of Example 1, wherein the query comprises a natural language query.

Example 3. The computer-implemented method of Example 1 or Example 2, wherein the level of breadth calculated for the natural language query includes a breadth score that indicates a degree of specificity relative to other previously analyzed queries.

Example 4. The computer-implemented method of any of Examples 1-3, wherein visually presenting the identified media items in a manner that corresponds to the determined level of breadth associated with the query includes presenting a single identified media item for a level of breadth that is below a specified threshold value.

Example 5. The computer-implemented method of any of Examples 1-4, wherein visually presenting the identified media items in a manner that corresponds to the determined level of breadth associated with the query includes presenting a plurality of identified media items for a level of breadth that is above a specified threshold value.

Example 6. The computer-implemented method of any of Examples 1-5, further comprising presenting, in the interactive user interface, one or more portions of textual information indicating why the identified media items were presented in the interactive user interface.

Example 7. The computer-implemented method of any of Examples 1-6, further comprising training a large language model (LLM) to generate the textual information indicating why the identified media items were presented in the interactive user interface.

Example 8. The computer-implemented method of any of Examples 1-7, wherein training the LLM includes feeding the LLM a plurality of inputs including a plurality of previous queries, a plurality of identified media items that were identified in response to the previous queries, and a plurality of modified portions of textual information indicating why the identified media items were presented in the interactive user interface.

Example 9. The computer-implemented method of any of Examples 1-8, wherein the trained LLM is implemented to identify the one or more media items that match the query.

Example 10. The computer-implemented method of any of Examples 1-9, wherein the trained LLM is further trained to avoid identifying specific media items as matches to one or more predetermined queries.

Example 11. The computer-implemented method of any of Examples 1-10, wherein the one or more portions of textual information indicating why the identified media items were presented in the interactive user interface are written in conversational language.

Example 12. The computer-implemented method of any of Examples 1-11, wherein the one or more portions of textual information indicating why the identified media items were presented in the interactive user interface include one or more tags.

Example 13. The computer-implemented method of any of Examples 1-12, wherein the identified matches comprise lexical matches that are lexically matched to the query.

Example 14. A system comprising at least one physical processor and physical memory comprising computer-executable instructions that, when executed by the physical processor, cause the physical processor to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

Example 15. The system of Example 14, wherein the physical processor is further configured to present, in the interactive user interface, one or more suggested prompts that are configured to be added to the received query to further refine the resulting identified media items.

Example 16. The system of Example 14 or Example 15, wherein the physical processor further receives one or more inputs via the suggested prompts and adds those inputs to an existing search to further refine the resulting identified media items.

Example 17. The system of any of Examples 14-16, wherein the physical processor is further configured to add a sub-search bar to the interactive user interface that allows a user to enter secondary, clarifying search query.

Example 18. The system of Examples 14-17, wherein the physical processor receives a secondary, clarifying search query via the sub-search bar and performs an updated search using the query and the secondary, clarifying search query.

Example 19. The system of any of Examples 14-18, wherein the physical processor dynamically updates the interactive user interface to show one or more different media items based on the query and the secondary, clarifying search query.

Example 20. A non-transitory computer-readable medium comprising one or more computer-executable instructions that, when executed by at least one processor of a computing device, cause the computing device to: receive a query at a media streaming platform for one or more media items that are to be provisioned by the media streaming platform, analyze the query to determine a level of breadth associated with the query, the level of breadth indicating a degree of specificity associated with the query, identify one or more media items that match the query, and present the identified media items in an interactive user interface, wherein the identified media items are visually presented in a manner that corresponds to the determined level of breadth associated with the query.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
receiving a query at a media streaming platform for one or more media items that are to be provisioned by the media streaming platform;
analyzing the query to determine a level of breadth associated with the query, the level of breadth indicating a degree of specificity associated with the query;
identifying one or more matching media items that match the query;
generating, utilizing a large language model (LLM), textual information corresponding to the one or more matching media items and the level of breadth of the query; and
presenting the one or more matching media items and the textual information in an interactive user interface, wherein the one or more matching media items are visually presented in a manner that corresponds to the level of breadth associated with the query.

2. The computer-implemented method of claim 1, wherein the query comprises a natural language query.

3. The computer-implemented method of claim 2, wherein the level of breadth calculated for the natural language query includes a breadth score that indicates the degree of specificity relative to other previously analyzed queries.

4. The computer-implemented method of claim 1, wherein visually presenting the one or more matching media items in a manner that corresponds to the level of breadth associated with the query includes presenting a single identified media item for a level of breadth that is below a specified threshold value.

5. The computer-implemented method of claim 1, wherein visually presenting the one or more matching media items in a manner that corresponds to the level of breadth associated with the query includes presenting a plurality of matching media items for a level of breadth that is above a specified threshold value.

6. The computer-implemented method of claim 1, further comprising presenting, in the interactive user interface, one or more portions of textual information indicating why the one or more matching media items were presented in the interactive user interface.

7. The computer-implemented method of claim 6, further comprising generating a trained LLM by training the LLM to generate the textual information indicating why the identified one or more matching media items were presented in the interactive user interface.

8. The computer-implemented method of claim 7, wherein training the LLM includes feeding the LLM a plurality of inputs including a plurality of previous queries, a plurality of identified media items that were identified in response to the plurality of previous queries, and the textual information indicating why the one or more matching media items were presented in the interactive user interface.

9. The computer-implemented method of claim 7, wherein the trained LLM is implemented to identify the one or more matching media items that match the query.

10. The computer-implemented method of claim 7, wherein the trained LLM is further trained to avoid identifying specific media items as matches to one or more predetermined queries.

11. The computer-implemented method of claim 6, wherein the one or more portions of textual information indicating why the one or more matching media items were presented in the interactive user interface are written in conversational language.

12. The computer-implemented method of claim 6, wherein the one or more portions of textual information indicating why the one or more matching media items were presented in the interactive user interface include one or more tags.

13. The computer-implemented method of claim 1, wherein the one or more matching media items comprise lexical matches that are lexically matched to the query.

14. A system comprising:
at least one physical processor; and
physical memory comprising computer-executable instructions that, when executed by the at least one physical processor, cause the at least one physical processor to:
receive a query at a media streaming platform for one or more media items that are to be provisioned by the media streaming platform;
analyze the query to determine a level of breadth associated with the query, the level of breadth indicating a degree of specificity associated with the query;
identify one or more matching media items that match the query;
generating, utilizing a large language model (LLM), textual information corresponding to the one or more matching media items and the level of breadth of the query; and
present the one or more matching media items and the textual information in an interactive user interface, wherein the one or more matching media items are visually presented in a manner that corresponds to the level of breadth associated with the query.

15. The system of claim 14, wherein the at least one physical processor is further configured to present, in the interactive user interface, one or more suggested prompts that are configured to be added to the query to further refine the one or more matching media items.

16. The system of claim 15, wherein the at least one physical processor further receives one or more inputs via the one or more suggested prompts and adds those inputs to an existing search to further refine the one or more matching media items.

17. The system of claim 14, wherein the at least one physical processor is further configured to add a sub-search bar to the interactive user interface that allows a user to enter secondary, clarifying search query.

18. The system of claim 17, wherein the at least one physical processor receives a secondary, clarifying search query via the sub-search bar and performs an updated search using the query and the secondary, clarifying search query.

19. The system of claim 18, wherein the at least one physical processor dynamically updates the interactive user interface to show one or more different media items based on the query and the secondary, clarifying search query.

20. A non-transitory computer-readable medium comprising one or more computer-executable instructions that, when executed by at least one processor of a computing device, cause the computing device to:
receive a query at a media streaming platform for one or more media items that are to be provisioned by the media streaming platform;
analyze the query to determine a level of breadth associated with the query, the level of breadth indicating a degree of specificity associated with the query;
identify one or more matching media items that match the query;
generating, utilizing a large language model (LLM), textual information corresponding to the one or more matching media items and the level of breadth of the query; and
present the one or more matching media items and the textual information in an interactive user interface, wherein the one or more matching media items are visually presented in a manner that corresponds to the level of breadth associated with the query.
